(19) United States
(12) Patent Application Publication
(10) Pub. No.: US 2013/0204629 A1
(43) Pub. Date: Aug. 8, 2013

(54) VOICE INPUT DEVICE AND DISPLAY DEVICE

(71) Applicant: PANASONIC CORPORATION, Osaka (JP)

(72) Inventor: Masahiro NAKANISHI, Kyoto (JP)

(73) Assignee: PANASONIC CORPORATION, Osaka (JP)

(21) Appl. No.: 13/783,774

(22) Filed: Mar. 4, 2013

Related U.S. Application Data
(63) Continuation of application No. PCT/JP2012/005774, filed on Sep. 12, 2012.

(30) Foreign Application Priority Data
Feb. 8, 2012 (JP) 2012-024704

(51) Int. Cl. G06F 3/01

(52) U.S. Cl. CPC G06F 3/01
USPC 704/275; 381/160

(57) ABSTRACT

An voice input device includes a wave guide unit for guiding an incident sound wave, a microphone unit for converting a sound wave guided through the wave guide unit to an electrical sound signal, and a signal processing unit for processing the sound signal obtained by the microphone unit, using an acoustic characteristic given by the wave guide unit to the sound wave, in which, the wave guide unit has a structure which gives the acoustic characteristic that is different between direct sound, which is sound that reaches the microphone unit without reflecting off an internal surface of the wave guide unit, and indirect sound, which is sound that is reflected off the internal surface before reaching the microphone unit, and the signal processing unit determines whether or not the direct sound is input based on a difference in the acoustic characteristic between the direct sound and the indirect sound.

### CROSS REFERENCE TO RELATED APPLICATIONS

This is a continuation application of PCT International Application No. PCT/JP2012/005774 filed on Sep. 12, 2012, designating the United States of America, which is based on and claims priority of Japanese Patent Application No. 2012-024704 filed on Feb. 8, 2012. The entire disclosures of the above-identified applications, including the specifications, drawings and claims are incorporated herein by reference in their entirety.

### FIELD

The present disclosure relates to a voice input device for providing a predetermined control in response to an input voice and a display device for switching a display state in response to the input voice.

### BACKGROUND

Patent literature 1 discloses a device for providing a control in response to a voice. This device includes a display unit for displaying a musical score and a microphone built into the device. The device automatically displays a next page of the score by recognizing tone such as a voice inputted into the microphone or sound from an instrument and identifying a playing part in a current page displayed on the display unit. With the device, a player need not take his/her hand off the instrument to turn the pages of the score.

However, in this device, a player need not turn the pages of the score with his/her hand during a normal performance, but the player needs to manually operate the device using an update switch during practice.

In contrast, it is conceivable that the pages of the score are turned using voice from the player for example. In this case, the player can turn the pages of the score without using his/her hand at a desired time.

### CITATION LIST

### Patent Literature

Japanese Unexamined Patent Application Publication No. 11-153991

### SUMMARY

### Technical Problem

However, in the conventional device as described above, for example, when the device is placed on a music stand of a piano and a player turns the pages of a musical score using voice while playing the piano, a microphone further receives the voice while receiving piano sound, which means that the voice is superimposed on the piano sound. The conventional device as described above has a problem that it cannot always accurately display the next page of the score because it is very difficult to distinguish between the voice and the piano sound.

One non-limiting and exemplary embodiment provides a voice input device which is capable of precisely detecting an input of voice (direct sound). One non-limiting and exemplary embodiment provides a display device which can precisely detect the input of the voice (direct sound) and accurately display one or more next pages of the score.

### Solution to Problem

An voice input device according to the present disclosure includes a wave guide unit for guiding an incident sound wave, a microphone unit for converting a sound wave that has passed through the wave guide unit to an electrical sound signal, and a signal processing unit for performing signal processing on the sound signal obtained in the conversion by the microphone unit, using an acoustic characteristic that is given by the wave guide unit to the sound wave, in the voice input device, the wave guide unit has a structure which gives the acoustic characteristic that is different between direct sound and indirect sound of the sound wave that has passed through the wave guide unit and entered the microphone unit, the direct sound being sound that reaches the microphone unit without reflecting off an internal surface of the wave guide unit, the indirect sound being sound that is reflected off the internal surface before reaching the microphone unit, and the signal processing unit performs a direct-sound detection process which determines whether or not the direct sound is input, using a difference in the acoustic characteristic between the direct sound and the indirect sound.

It should be noted that the device according to the present disclosure can be implemented not only as such a device but also as: a method which includes, as steps, process units included in such a device; a program which causes a computer to execute such steps; a recording medium such as a computer readable CD-ROM storing such a program; or information, data, or a signal which represents such a program. These program, information, data, and a signal may be distributed via a communication network such as the Internet.

### Advantageous Effects

A voice input device according to the present disclosure is useful to precisely detect an input of voice (direct sound).

### BRIEF DESCRIPTION OF DRAWINGS

These and other objects, advantages and features of the invention will become apparent from the following description thereof taken in conjunction with the accompanying drawings that illustrate a specific embodiment of the present invention.

[FIG. 1]

FIG. 1 illustrates an outline view of a score display device including a voice input device according to an embodiment 1.

[FIG. 2]

FIG. 2 illustrates a cross-sectional view of the score display device along the line A-A′ shown in FIG. 1.

[FIG. 3]

FIG. 3 illustrates a block diagram showing a configuration of a signal processing unit and a display control unit according to the embodiment 1.

[FIG. 4A]

FIG. 4A illustrates a perspective view showing an exemplary structure of a wave guide unit in the voice input device according to the embodiment 1.

[FIG. 4B]

FIG. 4B illustrates a perspective view showing a variation of the wave guide unit in the voice input device.

[FIG. 4C]

FIG. 4C illustrates a perspective view showing another variation of the wave guide unit in the voice input device.

[FIG. 5A]

FIG. 5A illustrates an example of indirect sound of a sound signal entering the voice input device.

[FIG. 5B]

FIG. 5B illustrates an example of direct sound of the sound signal entering the voice input device.

[FIG. 6A]

FIG. 6A illustrates a circuit diagram showing an acoustic equivalent circuit when the wave guide unit according to the embodiment 1 receives the indirect sound.

[FIG. 6B]

FIG. 6B illustrates a circuit diagram showing an acoustic equivalent circuit when the wave guide unit according to the embodiment 1 receives the direct sound.

[FIG. 7]

FIG. 7 illustrates a chart showing respective transfer characteristics of the acoustic equivalent circuits shown in FIG. 6A and FIG. 6B.

[FIG. 8]

FIG. 8 illustrates an example of physical amount as described in the embodiment 1.

[FIG. 9]

FIG. 9 illustrates a flow chart showing exemplary operation of a display control unit according to the embodiment 1.

[FIG. 10A]

FIG. 10A illustrates an exemplary view on a display unit of the score display device according to the embodiment 1.

[FIG. 10B]

FIG. 10B illustrates another exemplary view on the display unit of the score display device according to the embodiment 1.

[FIG. 10C]

FIG. 10C illustrates another exemplary view on the display unit of the score display device according to the embodiment 1.

[FIG. 11A]

FIG. 11A illustrates a variation of the view on the display unit of the score display device.

[FIG. 11B]

FIG. 11B illustrates another variation of the view on the display unit of the score display device.

[FIG. 11C]

FIG. 11C illustrates another variation of the view on the display unit of the score display device.

[FIG. 12]

FIG. 12 illustrates an exemplary steering wheel equipped with the voice input device.

### DESCRIPTION OF EMBODIMENT

The preferred embodiment of the present invention is described in detail with reference to the drawings. However, an unnecessary detailed description is omitted. For example, a detailed description of a well known matter or a repeated description of a matter substantially having the same structure is omitted. This is to avoid an unnecessary redundant description and enable those skilled in the art to readily understand the present invention.

It should be noted that inventors provide the accompanying drawings and the following descriptions in order to enable those skilled in the art to fully understand this disclosure, and which is not intended to limit the subject matter recited in Claims.

### Embodiment 1

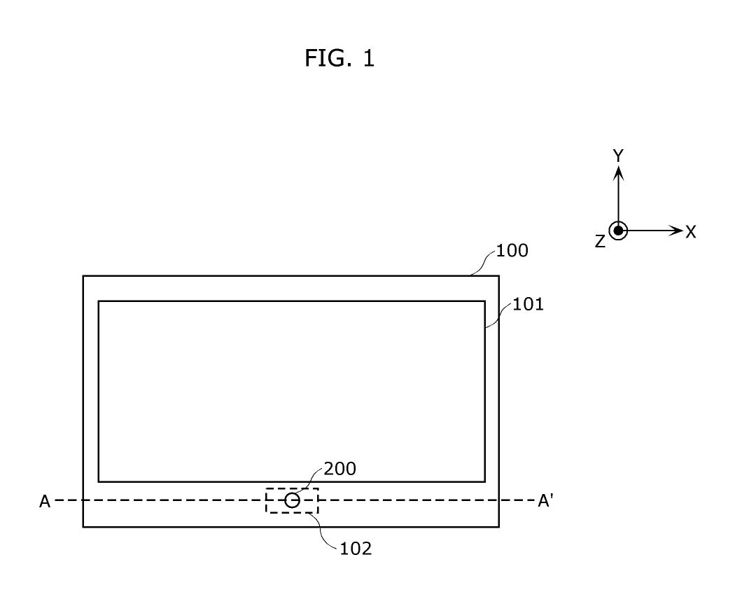

A display device including a voice input device according to an embodiment 1 is described hereinafter with reference to FIG. 1 to FIG. 10C.

### (1. Device Configuration)

First, a configuration of the display device is described with reference to FIG. 1 to FIG. 3.

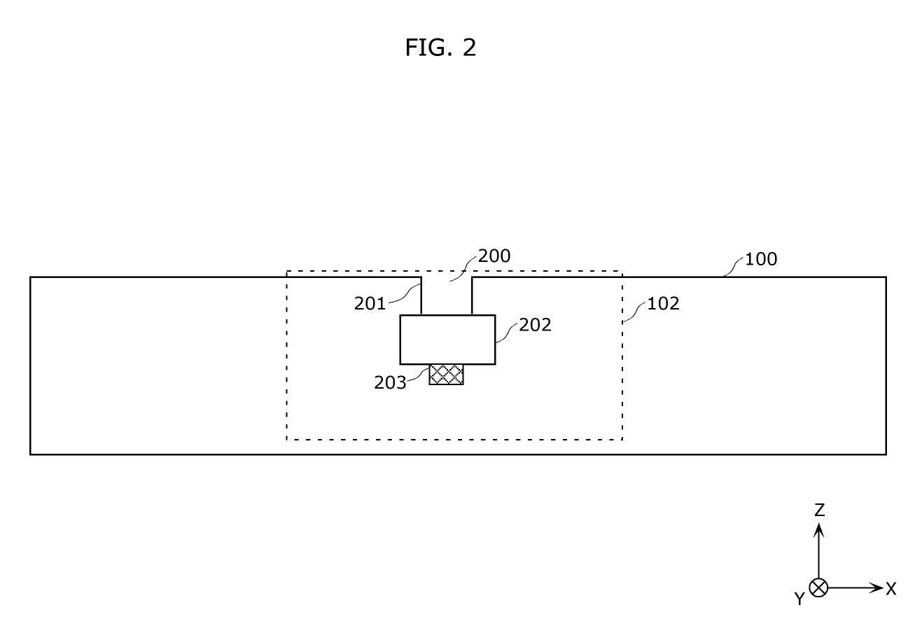

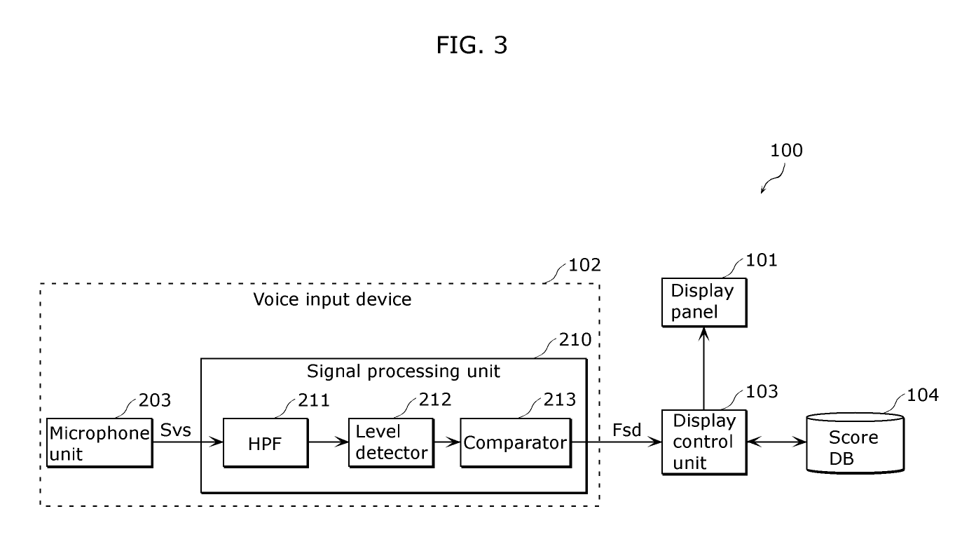

The embodiment describes a score display device for displaying a musical score as an exemplary display device. FIG. 1 illustrates an outline view showing a face with the display panel 101 in the score display device 100 that incorporates the voice input device according to the embodiment. FIG. 2 illustrates a cross-sectional view of the score display device 100 along the line A-A′ shown in FIG. 1. FIG. 3 illustrates a block diagram showing a configuration of components in the score display device 100 shown in FIG. 1.

The score display device 100 is a device for performing a “page-turning” process in which currently displayed pages of a musical score are switched to the next pages when a player's voice is detected. The embodiment further describes the score display device 100 which displays a piano score as an example. In the embodiment, the score display device is used on a music stand of a piano. Here, as an example, the score display device 100 is placed on the music stand so as to hold a long side of the score display device (x direction in FIG. 1) in a horizontal direction of the music stand.

The score display device 100 according to the embodiment is a tablet terminal equipped with a touch panel as an input interface, and includes the display panel 101, the voice input device 102, a display control unit 103, and a score DB 104 (a storing unit), as shown in FIG. 1 to FIG. 3. For the sake of facilitation of description, hereinafter, the long side of the display panel 101 shown in FIG. 1 is referred to as x-axis, a short side of the display panel is referred to as y-axis, and a display direction of the display panel 101 is referred to as z-axis.

The score display device 100 according to the embodiment is flattened in shape. As shown in FIG. 1, the display panel 101 and an opening portion to receive sound are provided on the surface of the score display device 100. In the embodiment, the opening portion of the score display device 100 is integrated with an opening portion of a wave guide unit 200 in the voice input device 102 as described below.

The display panel 101 displays the score of performed music. The display panel 101 can be manufactured using a typical panel. In the embodiment, the display panel 101 is a display panel in the tablet terminal. However, when the score display device 100 is another device such as a smart phone, it is preferable that the display panel 101 be a display panel provided to the device.

The voice input device 102 according to the embodiment is a device which can receive the voice of a player playing music (direct sound) and sound other than the voice of the player (indirect sound), e.g. instrument sound and others, and detect an input of the direct sound. In the embodiment, as described below, the voice input device 102 distinguishes between the indirect sound and the direct sound. The indirect sound is sound other than the voice, and includes sound of an instrument played by a player. The direct sound is sound by which the player gives a “page-turning” instruction to the score display device 100.

As shown in FIG. 2 and FIG. 3, the voice input device 102 includes the wave guide unit 200, a microphone unit 203, and a signal processing unit 210.

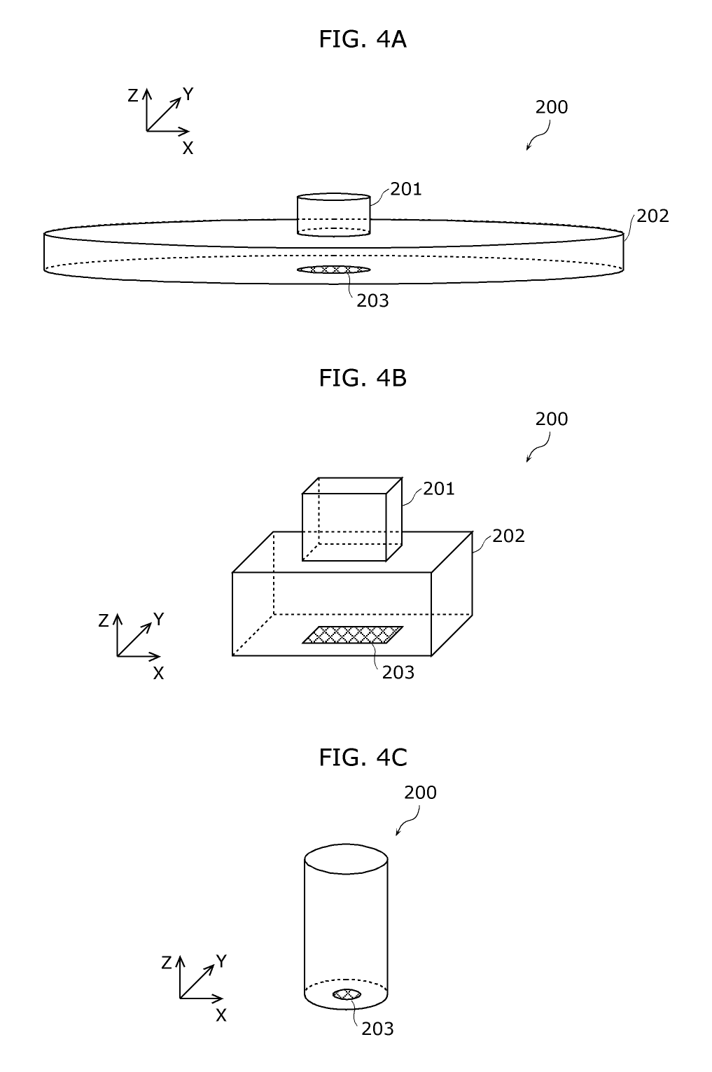

The wave guide unit 200 is a hollow member with the opening portion to receive sound, and the sound passes through a hollow portion (a wave is guided). FIG. 4A illustrates a perspective view showing a shape of the wave guide unit 200 according to the embodiment (a shape of the hollow portion). As shown in FIG. 4A, the wave guide unit 200 comprises an upper wave guide unit 201 and a lower wave guide unit 202. It should be noted that, for the sake of brevity, the embodiment describes the upper wave guide unit 201 and the lower wave guide unit 202 each having a hollow portion that is cylindrical in shape.

As shown in FIG. 4A, the upper wave guide unit 201 is located at a sound input side of the wave guide unit 200. The upper wave guide unit 201 has a top surface that is the opening portion to receive sound and a bottom surface that is on a top surface of the lower wave guide unit 202 as described below. The hollow portion of the upper wave guide unit 201 has a bottom-surface diameter (a diameter on a cross-sectional surface of the hollow portion parallel to X-Y plane shown in FIG. 4A) in the range from a few millimeters to a few centimeters. The hollow portion of the upper wave guide unit 201 also has a height (a height of the cylinder) in the range from a few millimeters to a few centimeters. It should be noted that the shape of the upper wave guide unit 201 including the hollow portion is determined by taking into consideration a size or a shape of the lower wave guide unit 202, a size or a shape of the score display device 100, and the like.

As shown in FIG. 4A, the lower wave guide unit 202 is located at a sound output side (a microphone unit 203 side) of the wave guide unit 200. The lower wave guide unit 202 has a top surface that is in contact with the bottom surface of the upper wave guide unit 201 and a bottom surface on which a microphone is provided. A single space is formed in combination with the upper wave guide unit 201 and the lower wave guide unit 202. The hollow portion of the lower wave guide unit 202 has a bottom-surface diameter (a diameter on a cross-sectional surface of the hollow portion parallel to X-Y plane shown in FIG. 4A) which is set to a few centimeters that is greater than the diameter of the upper wave guide unit 201. The hollow portion of the lower wave guide unit 202 also has a height (a height of the cylinder) in the range from a few millimeters to a few centimeters.

The shape of the wave guide unit 200 is characterized in that a size of the opening portion (an open area) of the lower wave guide unit 202 is larger than a size of the opening portion (an open area) of the upper wave guide unit 201. This is to cause Helmholtz resonance to occur within the wave guide unit 200 as described below. It should be noted that the wave guide unit may be made of any of a plastic, metal, wood, and others.

The microphone unit 203 is disposed on the bottom of the wave guide unit 200 (an end portion in the z-direction of the wave guide unit 200). The microphone unit 203 converts, into an electrical signal, a sound wave (a sound signal) including the voice from a person (direct sound), instrument sound such as piano sound (indirect sound), and others, which come from the wave guide unit 200. The sound signal converted into the electrical signal is provided to the signal processing unit 210.

The signal processing unit 210 detects an input of the direct sound by electrically handling the electrical signal provided from the signal processing unit 210, and outputs the result to the display control unit 103. Specific processes will be described below.

The display control unit 103 updates pages of the score to be displayed on the display panel 101 based on the output from the signal processing unit 210.

The score DB 104 is a DB storing score data to be displayed on the display panel. In the embodiment, the score DB is a non-volatile memory.

### (2. Characteristics of Wave Guide Unit 200 for Direct Sound and Indirect Sound)

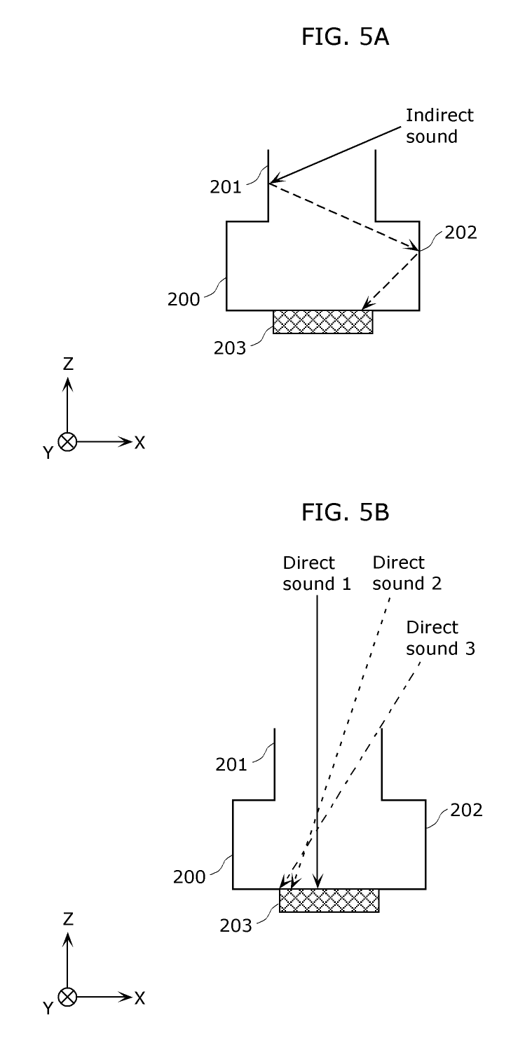

The following paragraphs describe a direct-sound detection process which is performed by the signal processing unit 210 in the score display device 100 with reference to FIG. 5A to FIG. 8.

FIG. 5A illustrates a diagram showing a cross-sectional view of the wave guide unit 200 on the XZ plane and an exemplary path of the indirect sound to the microphone unit 203. FIG. 5B illustrates a diagram showing the cross-sectional view of the wave guide unit 200 on the XZ plane and an exemplary path of the direct sound to the microphone unit 203. It should be noted that, in FIG. 5A and FIG. 5B, for illustrative purpose, a ratio between the diameter and the height is different from an actual ratio of the wave guide unit 200. As shown in FIG. 5A, the indirect sound entering the wave guide unit 200 is reflected off a side wall of the wave guide unit 200 before reaching the microphone unit 203. In contrast, as shown in FIG. 5B, the direct sound entering the wave guide unit 200 directly reaches the microphone unit 203 without reflecting off the side wall of the wave guide unit 200. It should be noted that FIG. 5B illustrates direct sound 1, direct sound 2, and direct sound 3, but these are not simultaneously occurring sounds but just patterns of possible paths.

In the embodiment, the voice from a player reaches the microphone unit 203 as the direct sound since the score display device 100 is placed on the music stand of the piano as described above. On the other hand, piano sound reaches the microphone unit 203 as the indirect sound. Here, some piano sound is reflected off a wall of a room before coming to the wave guide unit. However, since a user serves as a barrier, such sound is expected not to reach the microphone unit 203 as the direct sound or to reach the microphone unit 203 after being sufficiently attenuated to a level in which the direct-sound detection process is not affected.

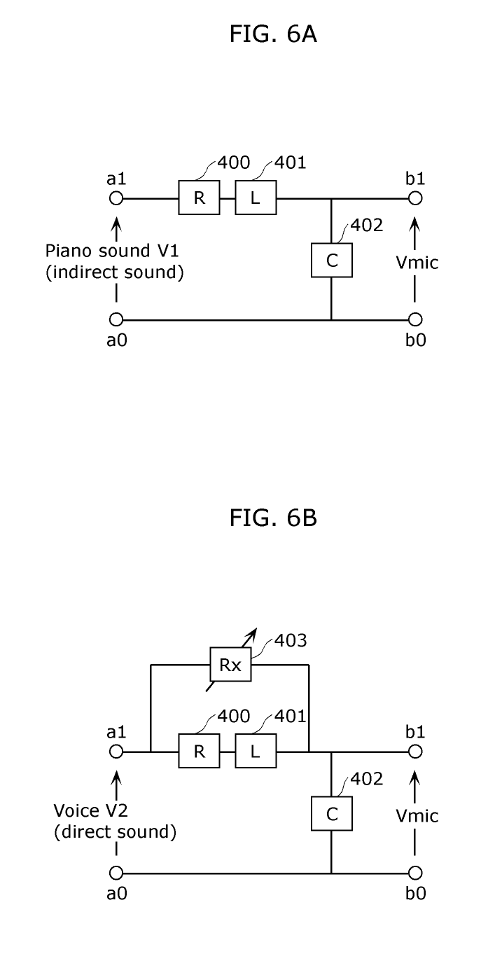

Inventors of this application found that (i) a relationship between sound pressure V1 of the indirect sound that has passed through the wave guide unit 200 and sound pressure Vmic of the microphone unit 203 and (ii) a relationship between sound pressure V2 of the direct sound that has passed through the wave guide unit 200 and the sound pressure Vmic of the microphone unit 203 are different. FIG. 6A illustrates an acoustic equivalent circuit for the indirect sound (the sound pressure V1 of the piano sound). FIG. 6B illustrates an acoustic equivalent circuit for the direct sound (the sound pressure V2 of the voice from the player). The inventors also found, based on the wave guide unit 200, that the acoustic equivalent circuit shown in FIG. 6A is appropriate for the indirect sound, and the acoustic equivalent circuit shown in FIG. 6B is appropriate for the direct sound.

More specifically, for the indirect sound (the piano sound), Helmholtz resonance occurs within the wave guide unit 200. In other words, the upper wave guide unit 201 in the wave guide unit 200 can be represented as an electrical circuit with an acoustic inertance element L (401) and an acoustic resistance element R (400) which are connected in series. On the other hand, the lower wave guide unit 202 can be represented as an electrical circuit with a parallel-connected acoustic compliance element C (402). In view of this, for the indirect sound, as shown in FIG. 6A, the entire wave guide unit 200 can be represented as an electrical circuit including the acoustic resistance element R one end of which is connected to a terminal a1 and the other of which is connected to one end of the acoustic inertance element L, the acoustic inertance element L the other of which is connected to a terminal b1, and the acoustic compliance element C one end of which is connected to the terminal b1 and the other of which is connected to terminals a0 and b0. The voltage V1 of the terminal a1 with respect to the terminal a0 is represented as the sound pressure of the piano sound. The voltage Vmic of the terminal b1 with respect to the terminal b0 is a voltage measured at the microphone unit 203. This structure is a circuit configuration referred to as a resonance circuit.

On the other hand, for the direct sound (the voice from the player), although Helmholtz resonance occurs within the wave guide unit 200 like the indirect sound, the entire wave guide unit can be represented as an electrical circuit shown in FIG. 6B by setting the predetermined number of parameters. The acoustic equivalent circuit shown in FIG. 6B includes a variable resistance element Rx (403) which is connected in parallel to the series circuit comprising the acoustic resistance element R and the acoustic inertance element L (Rx is connected between the terminals a1 and b1), in addition to the components of the acoustic equivalent circuit shown in FIG. 6A. In this case, the variable resistance element Rx serves as a variable resistor which has a nearly infinite resistance value for a lower frequency and a resistance value closer to zero for a higher frequency.

The characteristics of the acoustic equivalent circuit shown in FIG. 6B shows that, in the wave guide unit 200, a shorter wavelength (a higher frequency) of an incident direct sound (such as the voice of the player) can more easily reach the microphone unit 203.

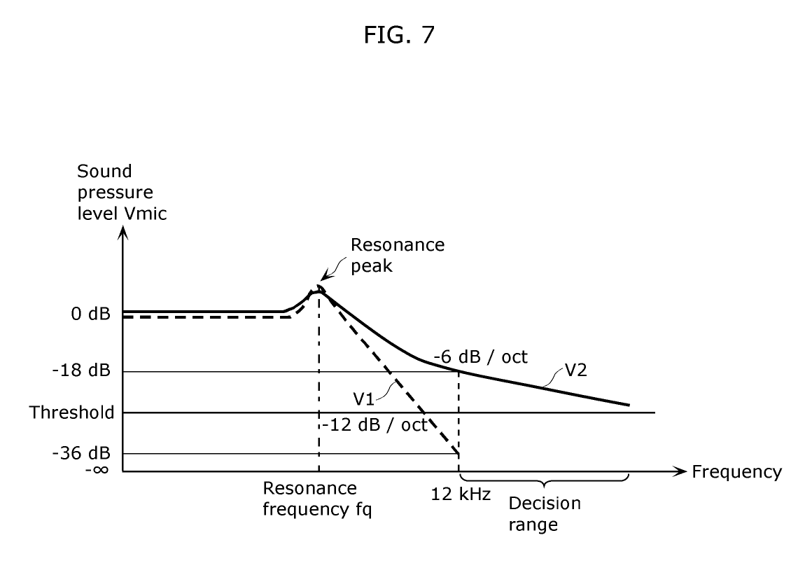

FIG. 7 illustrates a chart showing transfer characteristics of the acoustic equivalent circuit for the indirect sound, as shown in FIG. 6A, and transfer characteristics of the acoustic equivalent circuit for the direct sound, as shown in FIG. 6B. The vertical axis represents the sound pressure level Vmic of a sound signal of sound collected by the microphone unit 203 (a voltage of an electrical signal), and the horizontal axis represents a frequency of the collected electrical sound signal. In FIG. 7, a dashed line denotes amplitude-frequency characteristics of the acoustic equivalent circuit shown in FIG. 6A. Likewise, in FIG. 7, a solid line denotes amplitude-frequency characteristics of the acoustic equivalent circuit shown in FIG. 6B.

In a low frequency range of the incident direct sound, the acoustic equivalent circuit shown in FIG. 6B has characteristics similar to the characteristics of the acoustic equivalent circuit shown in FIG. 6A because the variable resistance element Rx is nearly infinite. On the other hand, in a high frequency range, the acoustic equivalent circuit shown in FIG. 6B has a higher volume flow velocity (corresponding to current), which flows into the variable resistance element Rx, than the series circuit comprising the acoustic resistance element R and the acoustic inertance element L because the variable resistance Rx is close to zero. For this reason, in the high frequency range of the direct sound, the sound attenuation per octave decreases compared to that of the indirect sound. The chart shown in FIG. 7 shows that, in the high frequency range, the direct sound (FIG. 6B) denoted by the solid line has a lower attenuation than the indirect sound (FIG. 6A) denoted by the dashed line.

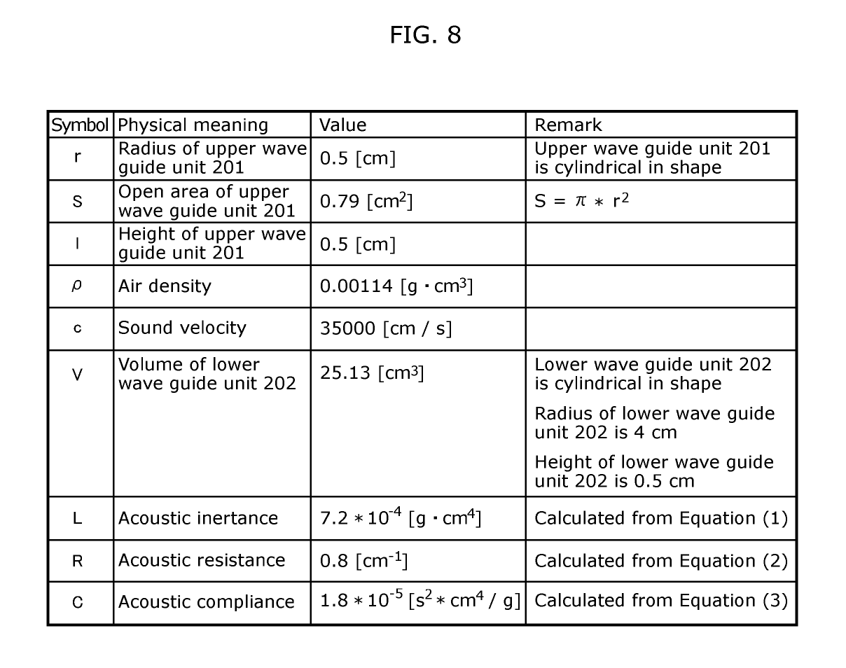

FIG. 8 illustrates an example of specific values for determining the characteristics of the wave guide unit 200 as described above. As shown in FIG. 8, the following description assumes that a radius of the upper wave guide unit 201 is r=0.5 cm, the open area is S=0.79 cm², the height is I=0.5 cm, an air density is ρ=0.00114 g·cm³, a sound velocity is c=35000 cm/s, and a volume of the lower wave guide unit 202 is V=25.13 cm³.

It is known that L, R, and C of the equivalent circuit as described above are given by the following Equations (1) to (3), respectively.

$$\begin{matrix}[ Math . 1 ] & \\ L = ρ l / S & ( 1 ) \\ [ Math . 2 ] & \\ R = r / {S}^{2} & ( 2 ) \\ [ Math . 3 ] & \\ C = ( \frac{V}{ρ {c}^{2}} ) & ( 3 )\end{matrix}$$

When the values shown in FIG. 8 are plugged into Equations (1) to (3), the acoustic inertance L=7.2×10⁻⁴ g·cm⁴, the acoustic resistance R=0.8 cm⁻¹, and the acoustic compliance C=1.8×10⁻⁵ s²·cm⁴/g are calculated as shown in FIG. 8, respectively.

In this case, a resonance frequency fq for the characteristics shown in FIG. 7 is given by Equation (4).

$$\begin{matrix}[ Math . 4 ] & \\ fq = \frac{1}{2 π} {( \frac{1}{LC} )}^{0.5} & ( 4 )\end{matrix}$$

With the specific value shown in FIG. 8, the resonance frequency fq is about 1.4 kHz. In the equivalent circuit for the indirect sound shown in FIG. 6A (the dashed line), the sound pressure level measured in the microphone unit 203 decreases by 12 dB per octave in a range above the resonance frequency fq. On the other hand, in the equivalent circuit for the direct sound shown in FIG. 6B (the solid line), the sound pressure level decreases by 6 dB per octave in the range above the resonance frequency fq. In the embodiment, such characteristics are used to detect an input of the direct sound.

In FIG. 7, a range with a large attenuation difference between the two acoustic equivalent circuits, for example, a range above 12 kHz, is defined as a determination frequency range (referred to as “decision range” in FIG. 7). In this case, the total number of octaves Noct in the range from the resonance frequency fq to a lower limit of the determination frequency range fmin is expressed by the following Equation (5).

[Math. 5]

Noct=LOG₂(f min/f_{q}) (5)

In an example in FIG. 7 and FIG. 8, assuming that the lower limit of the determination frequency range fmin is 12 kHz, Equation (5) of Noct=LOG₂(12/1.4) is about 3. This shows that the lower limit is a frequency about three octaves higher than the resonance frequency fq.

The sound pressure level V2 of the direct sound (voice, the solid line in FIG. 7) in the frequency range above the resonance frequency fq is expressed by the following Equation (6), where A2 is an attenuation rate (an absolute value) and V₂0 is an initial value (0 dB in FIG. 7).

[Math. 6]

V2=V₂0−A2×Noct (6)

In example in FIG. 7 and FIG. 8, the sound pressure level V2 of the voice at 12 kHz which is the lower limit of the determination frequency range, i.e. the sound pressure level V2 denoted by the solid line in FIG. 7, is obtained by Equation (6): 0 dB-6 dB×3=−18 dB.

The sound pressure level V1 of the indirect sound (piano sound, the dashed line in FIG. 7) in the frequency range above the resonance frequency fq is expressed by the following Equation (7), where A1 is an attenuation rate (an absolute value) and V₁0 is an initial value (0 dB in FIG. 7).

[Math. 7]

V1=V₁0=A1×Noct (7)

In example in FIG. 7 and FIG. 8, the sound pressure level V1 of the piano sound at 12 kHz which is the lower limit of the determination frequency range, i.e. the sound pressure level V1 denoted by the dashed line in FIG. 7, is obtained by Equation (7): 0 dB-12 dB×3=−36 dB.

However, the voice to be produced needs to include a level substantially equal to a level of frequency components above 12 kHz which are included in the piano sound. For this reason, it is preferable that the voice is a transient voice with precipitous leading edge or a consonant including a large number of high-frequency components, for example.

From the above description, a threshold is provided between −18 dB and −36 dB because the sound pressure level V2 of the direct sound at 12 kHz is −18 dB and the sound pressure level V1 of the indirect sound is −36 dB under a condition shown in FIG. 7 and FIG. 8. When the sound pressure level Vmic measured in the microphone unit 203 is greater than the threshold, it can be determined that the direct sound is input. It should be noted that FIG. 7 and FIG. 8 shows the case where the indirect sound and the direct sound received by the microphone unit 203 have the same sound pressure level in the low frequency range (V₁0=V₂0=0 dB) as an example. When the sound pressure level of the piano sound (the indirect sound) is higher than that of the direct sound (the initial value is greater than 0 dB), the dashed line shifts up on the chart. Even in this case, the input of the direct sound can be detected by providing the determination frequency range within a frequency range with a large difference between the sound pressure level V2 of the direct sound and the sound pressure level V1 of the indirect sound.

### (3. Direct-Sound Detection Process)

Next, a direct-sound detection process in the signal processing unit 210 is described in detail.

The signal processing unit 210 performs the direct-sound detection process where the input of the direct sound is detected using a difference in the acoustic characteristic between the direct sound and the indirect sound as shown in FIG. 7. Upon detecting the direct sound in the direct-sound detection process, the signal processing unit 210 provides a control signal referred to as a display switching flag Fsd in the embodiment, to the following display control unit 103.

The signal processing unit 210 includes a low-cut filter (HPF) 211, a level detector 12, and a comparator 213, as shown in FIG. 3.

The HPF 211 removes or attenuates signals in a specific range, i.e. a range other than the determination frequency range. In the HPF 211, a cutoff frequency to remove or attenuate the signals is set based on the resonance frequency fq derived from the shape of the wave guide unit 200 or the like. For example, since the range above 12 kHz is defined as the determination frequency range in FIG. 7 and FIG. 8, the HPF 211 is preferably a high-order low-cut filter which precipitously cuts signals in a range below 12 kHz.

The level detector 212 detects a level of the sound signal provided from the HPF 211.

The comparator 213 compares a predetermined threshold to the level value detected by the level detector 212. As a result, when the level value detected by the level detector 212 is greater than the predetermined threshold, the control signal to instruct to switch display content (the display switching flag Fsd) is provided to the next display control unit. The example shown in FIG. 7 and FIG. 8 selects −25 dB as the predetermined threshold because the voice has the sound pressure level of −18 dB at 12 kHz and the piano sound has the sound pressure level of −36 dB. With this threshold, when only the piano sound is received, the control signal is not provided because the level value of −36 dB detected by the level detector 212 is smaller than the threshold of −25 dB. In contrast to this, when the direct sound is received, the control signal is provided because the level value of −18 dB detected by the level detector 212 is greater than the threshold of −25 dB. Thus, the display switching flag can be provided in response to only the voice by setting the threshold to a value between the result in Equation (6) and the result in Equation (7).

From the above, the wave guide unit 200, the microphone unit 203 which collects sound that has passed through the wave guide unit 200, and the signal processing unit 210 which performs a signal process on a signal provided from the microphone unit 203 can be used to precisely detect the input of the direct sound even in an environment where one or both of the direct sound and the indirect sound or mixed sound is received.

More specifically, with the wave guide unit 200, which gives the acoustic characteristic that is different between the direct sound and the indirect sound included in sound collected by the microphone unit 203 after passing through the wave guide unit 200, the direct sound can be more easily distinguished from the indirect sound, and thus allowing only the direct sound to be extracted. The signal processing unit can select only the signal to be extracted, using a difference in the acoustic characteristic. It should be noted that when the wave guide unit 200 has the cross-sectional area of the sound input side (the upper wave guide unit 201) smaller than that of the sound collected side (the lower wave guide unit 202), there is a large difference in the acoustic characteristic between the direct sound and the indirect sound based on Helmholtz resonance principle, and thus the direct sound can be detected more easily. Here, the cross-sectional area is a cross-sectional area on a plane perpendicular to the path of the sound which vertically enters the microphone unit 203. For example, in FIG. 4A, the cross-sectional area is a cross-sectional area on a plane perpendicular to the z-axis.

It should be also noted that, in the embodiment, the acoustic characteristic means an amount of the attenuation in a frequency range above the resonance frequency. In the frequency range above the resonance frequency, the amount of the attenuation per octave is different between the direct sound and the indirect sound. For this reason, in the frequency range above the resonance frequency, since the attenuation amount of signal level for the direct sound is lower than that for the indirect sound, so that the signal level of the direct sound is greater than that of the indirect sound. Thus, the signal processing unit 210 can distinguish between the direct sound and the indirect sound using the signal level in the frequency range above the resonance frequency.

### (4. Switching of a Score Display)

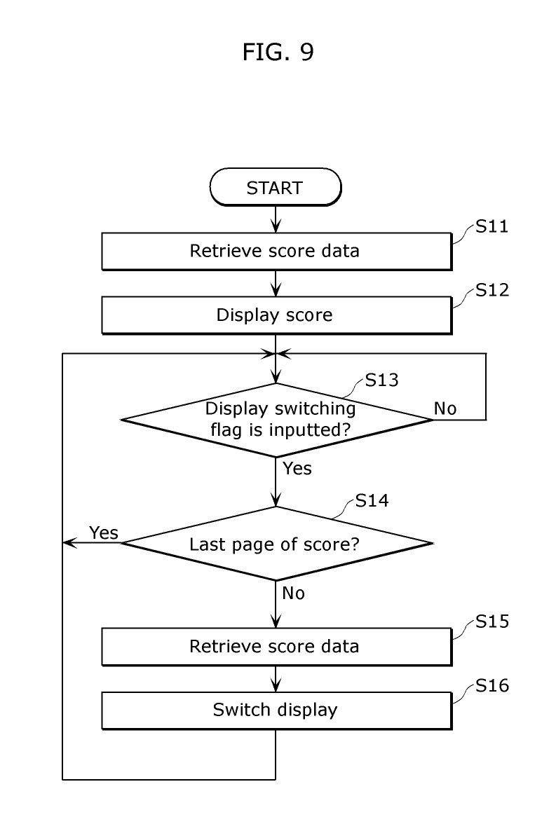

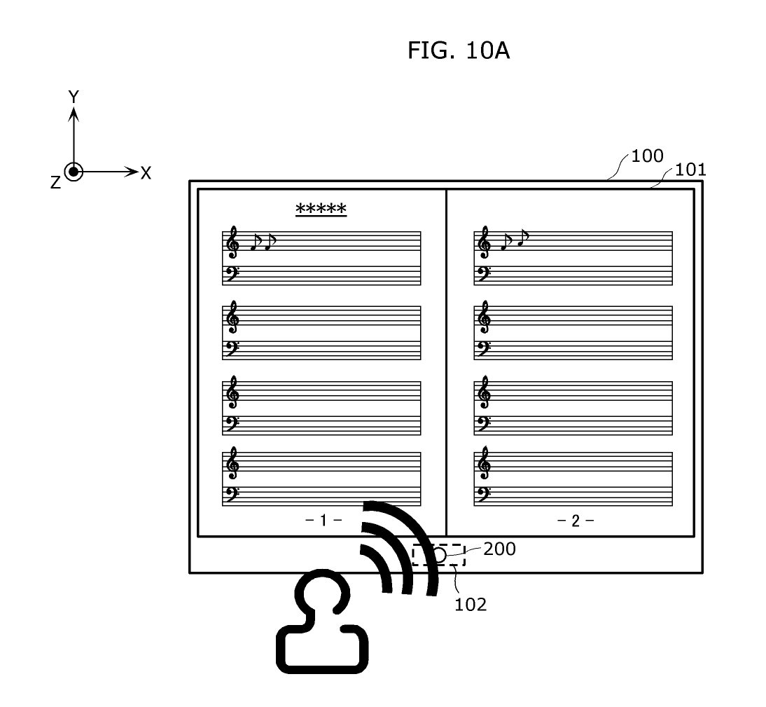

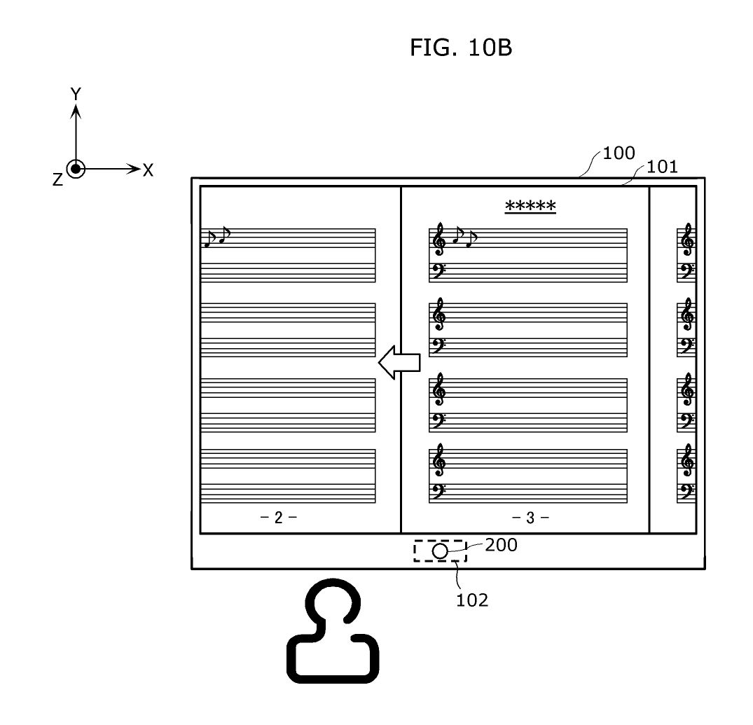

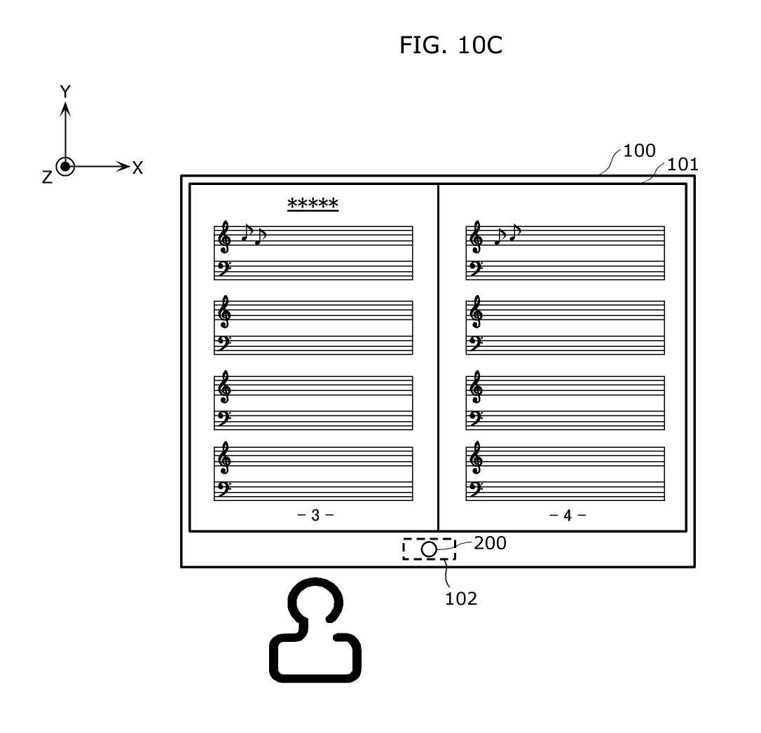

Next, a display switching process in the display control unit 103 is described in detail with reference to FIG. 9 to FIG. 10C. FIG. 9 illustrates a flow chart showing a procedure of the display switching process. Each of FIG. 10A to FIG. 10C illustrates a view on the display panel 101 at a corresponding one of the steps shown in FIG. 9.

After an application program for displaying the score is invoked and the score and its pages to be displayed are specified, the display control unit 103 retrieves, from the score DB 104, display data for the specified pages of the score (Step S11). It should be noted that only data for appropriate pages may be retrieved from a cache memory after data for all pages of the score is written into the cache memory such as a random access memory (RAM).

The display control unit 10 causes the display panel 101 to display the score, using the retrieved display data (Step S12). In an example shown in FIG. 10A, two pages of the score are displayed on the display panel 101. In particular, pages 1 and 2 are displayed.

As shown in FIG. 10A, when the display switching flag Fsd is provided from the signal processing unit 210 (Yes in Step S13) and currently displayed pages of the score do not include the last page (No in Step S14), the display control unit 103 retrieves, from the score DB, pages following the currently displayed pages (Step S15).

The display control unit 103 causes the display panel 101 to display the retrieved pages (Step S16). Here, in the display control unit 103 according to the embodiment, the pages of the score are displayed by scrolling through the pages. FIG. 10B illustrates a view on the display panel 101 during the switching of the pages of the score. FIG. 10C illustrates a view on the display panel 101 after the switching of the pages of the score. It should be noted that the pages are horizontally scrolled in FIG. 10B and FIG. 10C as an example, but not limited to this. The display control unit 103 may switch to the next display by vertically scrolling through the pages. Instead of scrolling, the display control unit 103 may also switch instantaneously or by any other method.

In Step S14, when the currently displayed pages of the score include the last page, the procedure of the display control unit 103 skips Step S15 and Step S16, and then proceeds to Step S13.

It should be noted that the display control unit 103 terminates the score display on the display panel 101 when the display control unit receives a signal for terminating the score display at a given point in time (not shown in FIG. 9). Furthermore, in the embodiment, although the display is switched in only one direction as an example, the switching direction of the pages may be changed according to the number of direct-sound detections within a given period of time.

### (5. Effects)

As described above, in the embodiment, the signal processing unit in the voice input device performs the signal process using the difference in the acoustic characteristic between the direct sound, which directly reaches the microphone unit without reflecting off an internal surface of the wave guide unit, and the indirect sound, which indirectly reaches the microphone unit after being reflected off the internal surface (inner wall). Here, the difference in the acoustic characteristic between the direct sound and the indirect sound means that in the frequency range above a predetermined frequency, for example, the frequency range above the resonance frequency, the attenuation amount of sound pressure level for the indirect sound is greater than that for the direct sound, as described above. Thus, in the determination frequency range provided in the frequency range above the resonance frequency, there is a large difference in the sound pressure level between the direct sound and the indirect sound.

As described above, the input of the direct sound can be precisely detected since the signal processing unit according to the embodiment uses the difference in the sound pressure level between the direct sound and the indirect sound, which is caused by the difference in the attenuation amount, in the determination frequency range provided in the frequency range above the resonance frequency.

More specifically, the input of the direct sound can be precisely detected by providing a threshold between the lower limit of the sound pressure level for the direct sound and the upper limit of the sound pressure level for the indirect sound and determining whether or not the sound pressure level of the sound detected by the microphone unit is greater than or equal to the threshold.

The wave guide unit according to the embodiment is separated into an entry portion and an exit portion in order to clarify the difference in the acoustic characteristic between the direct sound and the indirect sound. The cross-sectional area of the upper wave guide unit which is the entry portion of the wave guide unit is smaller than the cross-sectional area of the lower wave guide unit which is the exist portion of the wave guide unit. The wave guide unit having such a structure produces a large difference in the acoustic characteristic between the direct sound and the indirect sound based on Helmholtz resonance principle.

The display device according to the embodiment can precisely detect the voice from a user by detecting the input of the direct sound through the voice input device as described above. With this, a display can be precisely switched in response to the voice from the user. An incorrect operation, for example, a display switching in response to sound other than the voice from the user, can be prevented, and the power consumption can be reduced.

### (Variations of the Embodiment)

(1) The embodiment describes the score display device 100 with a score DB stored on a memory in the device, but not limited to this. The score display device 100 may receive score data from another device such as a pocket server through a network, for example.

The embodiment also describes the score display device 100 which displays the piano score, but not limited to this. The score display device 100 can be applicable to a display device for displaying the score of the instrument such as an organ, which receives the instrument sound as the indirect sound and the voice from a player as the direct sound. In addition, the score display device 100 may display scores of several kinds of instruments.

(2) The embodiment describes the score display device 100 which is a tablet terminal, but not limited to this. The score display device 100 may be implemented as a smart phone or a dedicated device.

Furthermore, in the score display device 100, the display panel 101 and the voice input device 102 need not be implemented as the same device. For example, a tablet terminal or a smart phone may be used as the voice input device 102 and a display panel in another device or a dedicated display panel may be used as the display panel 101.

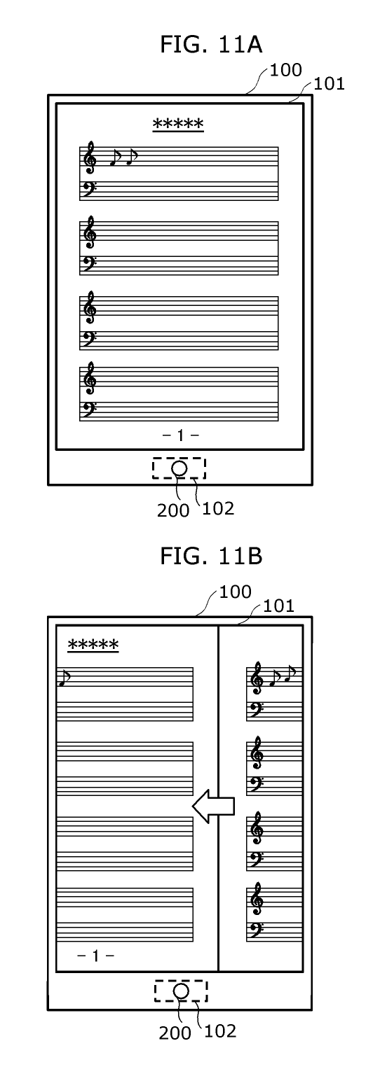

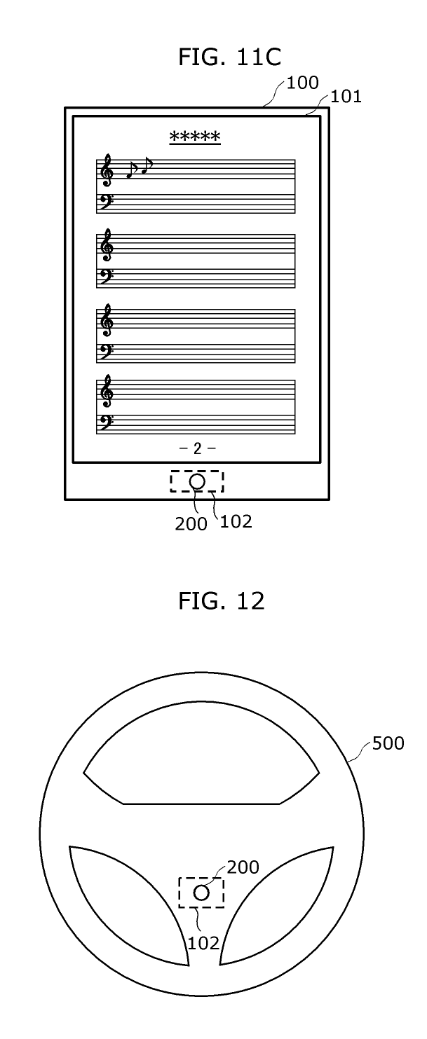

(3) The embodiment describes the display panel 101 which displays two pages of the score and is placed on the music stand so as to hold a long side of the display panel (x direction in FIG. 1) in a horizontal direction of the music stand, but not limited to this. The display panel may display one page of the score and is placed on the music stand so as to hold a short side of the display panel (y direction in FIG. 1) in the horizontal direction of the music stand. FIG. 11A to FIG. 11C illustrates a view on the display panel 101 which displays one page of the score. In this case, as shown in FIG. 11A to FIG. 11C, the voice input device 102 may be provided on the underside of the display panel 101 in a placed on the music stand.

It should be noted that in the embodiment, the display is switched from the pages 1 and 2 to the pages 3 and 4 when the display panel 101 displays two pages of the score, but not limited to this. For example, the display may be switched from the pages 1 and 2 to the pages 2 and 3.

(4) The embodiment describes the voice input device 102 which is integrated in the score display device 100 which displays the score, but not limited to this.

The voice input device 102 may be integrated in another display device which is used under an environment where both the direct sound and the indirect sound exists, for example, a digital photo frame with a music reproduction function. Such a display device switches a display when the direct sound is detected, for example.

It should be noted that the voice input device 102 may control not only a display operation but also any other operation using the direct-sound detection function of the voice input device 102 when the voice input device 102 is used for a device other than the score display device 100.

For example, a steering wheel equipped with the voice input device can be used as a device for detecting the voice of a driver (direct sound). In this case, when the voice of the driver is detected, an in-car device can perform an operation in response to the voice (for example, an on-off process of a car navigation system or an in-car AV equipment) by providing a voice detection signal to the in-car device.

FIG. 12 illustrates an exemplary steering wheel 500 equipped with the voice input device 102. As shown in FIG. 12, the voice input device 102 is integrated into the center of the steering wheel 500. With this configuration, the voice input device 102 receives the voice of the driver as the direct sound and any other sound such as the voice of a fellow passenger as the indirect sound.

(5) In the embodiment, the voice input device 102 only detects the direct sound and fails to analyze the content of the direct sound, but may analyze the content of the direct sound in the voice input device.
(6) In the embodiment, the wave guide unit 200 is formed in combination with two cylinders, but not limited to this. For example, the wave guide unit may be formed in combination with two square poles which have different cross-sectional areas as shown in FIG. 4B, or two cylinders which have the same cross-sectional areas as shown in FIG. 4B. It should be noted that the size of the upper wave guide unit 201 and the size of the lower wave guide unit 202 are appropriately determined by considering an installation space of the voice input device 102 in the score display device 100, a type of the indirect sound, a difference in frequency characteristics of the indirect sound caused by different kinds of instruments.
(7) The signal processing unit 210 and the display control unit 103 according to the embodiment is typically implemented as a large-scale integration (LSI) circuit, which is an integrated circuit. These may be integrated into a separate single chip, or some or all of the components may be integrated into a single chip. The name used here is a system LSI, however, it may also be referred to as an IC, an LSI, a super LSI, or an ultra LSI in accordance with the degree of integration. The integration may be achieved, not only as a LSI, but also as a dedicated circuit or a general purpose processor. Also applicable is a field programmable gate array (FPGA), which allows post-manufacture programming, or a reconfigurable processor LSI, which allows post-manufacture reconfiguration of connection and setting of circuit cells therein.

Furthermore, in the event that an advance in or derivation from semiconductor technology brings about an integrated circuitry technology whereby an LSI is replaced, the functional blocks may be obviously integrated using such new technology. The adaptation of biotechnology or the like is possible.

The signal processing unit 210 and the display control unit 103 may be implemented as a computer program (software) which causes a computer to execute steps of the signal processing unit 210 and the display control unit 103.

In this case, the computer program or the digital signal may be realized by storing the computer program or the digital signal in a computer readable recording medium such as flexible disc, a hard disk, a CD-ROM, an MO, a DVD, a DVD-ROM, a DVD-RAM, a BD (Blu-ray Disc), and a semiconductor memory. Furthermore, the present invention also includes the digital signal recorded in these recording media.

The computer program or the digital signal may also be realized by the transmission of the aforementioned computer program or digital signal via a telecommunication line, a wireless or wired communication line, a network represented by the Internet, a data broadcast and so on.

Furthermore, by transferring the program or the digital signal by recording onto the aforementioned recording media, or by transferring the program or digital signal via the aforementioned network and the like, execution using another independent computer system is also made possible.

As described above, the embodiment describes an exemplary voice input device and an exemplary display device. For this, accompanying drawings and detailed descriptions are provided.

As a result, in order to illustrate the above technique, the constituent elements recited in the accompanying drawings and the detailed descriptions can include not only constituent elements essential to solve the problems but also constituent elements not essential to solve the problems. For this reason, it should not be readily recognized that these non-essential constituent elements are essential by reciting the non-essential constituent elements in the accompanying drawings and the detailed descriptions.

In addition, the above embodiment is for the sake of illustration of the technique according to the present disclosure. Variations, replacement, addition, omission, or the like may be made within the scope of Claims or the equivalent scope.

### INDUSTRIAL APPLICABILITY

The present disclosure can be applicable to a device for providing a control in response to a voice. More specifically, the present disclosure can be applicable to a personal computer, an in-car device, or an electrical score using a display device such as a tablet.

1. A voice input device comprising:
a wave guide unit configured to guide an incident sound wave;
a microphone unit configured to convert a sound wave that has passed through the wave guide unit to an electrical sound signal; and
a signal processing unit configured to perform signal processing on the sound signal obtained in the conversion by the microphone unit, using an acoustic characteristic that is given by the wave guide unit to the sound wave,
wherein the wave guide unit has a structure which gives the acoustic characteristic that is different between direct sound and indirect sound of the sound wave that has passed through the wave guide unit and entered the microphone unit, the direct sound being sound that reaches the microphone unit without reflecting off an internal surface of the wave guide unit, the indirect sound being sound that is reflected off the internal surface before reaching the microphone unit, and
the signal processing unit is configured to perform a direct-sound detection process which determines whether or not the direct sound is input, using a difference in the acoustic characteristic between the direct sound and the indirect sound.

2. The voice input device according to claim 1,
wherein in the direct-sound detection process, the signal processing unit is configured to (i) determine whether or not a sound pressure level of the electrical sound signal is greater than or equal to a threshold in a determination frequency range which is provided in a range above a resonance frequency between the direct sound and the indirect sound, and (ii) detect an input of the direct sound when the sound pressure level of the electrical sound signal is determined to be greater than or equal to the threshold.

3. The voice input device according to claim 1,
wherein the signal processing unit includes:
a low-cut filter which removes or reduces a signal in a frequency range below a determination frequency that is provided in a range above a resonance frequency between the direct sound and the indirect sound; and
a comparator which compares a predetermined threshold to a level of an output signal from the low-cut filter, and provides a control signal indicating detection of the direct sound when the level of the output signal from the low-cut filter is greater than the predetermined threshold.

4. The voice input device according to claim 1,
wherein the wave guide unit has an upper wave guide unit which the sound wave enters and a lower wave guide unit to which the microphone unit is provided, and
a cross-sectional area of the upper wave guide unit is smaller than a cross-sectional area of the lower wave guide unit.

5. A display device comprising:
the voice input device according to claim 1;
a display panel which displays display data per unit of display;
a storing unit configured to store the display data; and
a display control unit configured to switch a display on the display panel from a current unit of display to a next unit of display when the input of the direct sound is detected by the signal processing unit in the voice input device.

6. The display device according to claim 5,
wherein the storing unit is configured to store, as the display data, score data for displaying a musical score,
the display panel displays the score data per unit of display, the unit of display including one or more pages of the musical score, and
the display control unit is configured to switch the display on the display panel so as to include a page following a last page of currently displayed one or more pages of the musical score when the input of the direct sound is detected.
